(19) United States
(12) Patent Application Publication
(10) Pub. No.: US 2026/0093388 A1
(43) Pub. Date: Apr. 2, 2026

(54) IMAGE PROCESSING METHOD, ELECTRONIC DEVICE, AND STORAGE MEDIUM

(71) Applicant: Beijing Zitiao Network Technology Co., Ltd., Beijing (CN)

(72) Inventors: Yiding WANG, Beijing (CN); Boyang XIE, Beijing (CN)

(21) Appl. No.: 19/342,660

(22) Filed: Sep. 28, 2025

(30) Foreign Application Priority Data
Sep. 29, 2024 (CN) 202411375538.0

(51) Int. Cl. G06F 3/04845; G06F 3/04847; G06F 3/0486; G06T 1/60; G06T 5/20

(52) U.S. Cl. CPC G06F 3/04845; G06F 3/04847; G06F 3/0486; G06T 1/60; G06T 5/20

(57) ABSTRACT

An image processing method, electronic device, and storage medium are provided. The image processing method includes: displaying an image editing interface, the image editing interface including at least one node identifier corresponding to an image editing node, and the image editing node including a filter image conversion node; adding, in response to an identifier triggering operation on the node identifier corresponding to the filter image conversion node, the filter image conversion node to the image editing interface; obtaining, in response to an image setting operation on the filter image conversion node, a set first filter image, and converting the first filter image into a second filter image through the filter image conversion node.

### CROSS-REFERENCE TO RELATED APPLICATION

The present disclosure claims priority of the Chinese Patent Application No. 202411375538.0 filed on Sep. 29, 2024, the disclosure of which is incorporated herein by reference in its entirety as part of the present application.

### TECHNICAL FIELD

The present disclosure relates to an image processing method, an electronic device, and a storage medium.

### BACKGROUND

In an image processing or video production scenario, the application of effect is highly favored by users. Effect can be produced by using an effect production tool. Filter effect can be produced based on the effect production tool, and then, the produced filter effect can be used to filter images and/or videos, so as to obtain filter effect images or videos.

When an image is filtered based on a filter effect, it is usually needed to filter the image by using a filter image resource with a specific format. Many common filter image resources exist and are used in the form of Look-Up Table (LUT) graphs, and the filter image resources with this format cannot be directly applied to images to obtain filter effect. It is usually needed to convert the format of LUT graphs by using a variety of external tools. Moreover, in the case of poor effect of the obtained filter effect, it is needed to turn to the external tools to adjust the filter image resources. This filter image processing method requires users to proficiently use a variety of external tools, which is extremely cumbersome, laborious and inefficient, making it difficult to meet the needs of filtering large quantities of images.

### SUMMARY

An embodiment of the present disclosure provides an image processing method, including: displaying an image editing interface, wherein the image editing interface comprises at least one node identifier corresponding to an image editing node, and the image editing node comprises a filter image conversion node; adding, in response to an identifier triggering operation on the node identifier corresponding to the filter image conversion node, the filter image conversion node to the image editing interface; and obtaining, in response to an image setting operation on the filter image conversion node, a set first filter image, and converting the first filter image into a second filter image through the filter image conversion node.

An embodiment of the present disclosure provides an image processing apparatus, including: an editing interface display module, configured to display an image editing interface, wherein the image editing interface includes at least one node identifier corresponding to an image editing node, and the image editing node includes a filter image conversion node; a conversion node adding module, configured to add, in response to an identifier triggering operation on the node identifier corresponding to the filter image conversion node, the filter image conversion node to the image editing interface; and a filter image generation module, configured to obtain, in response to an image setting operation on the filter image conversion node, a set first filter image, and to convert the first filter image into a second filter image through the filter image conversion node.

An embodiment of the present disclosure provides an electronic device, including at least one processor; and at least one memory, configured to store at least one program. When the at least one program is executed by the at least one processor, the at least one processor is caused to implement any image processing method of embodiments of the present disclosure.

An embodiment of the present disclosure provides a non-transitory computer-readable storage medium, containing computer-executable instructions. The computer-executable instructions, when executed by a computer processor, are configured to execute any image processing method of embodiments of the present disclosure.

An embodiment of the present disclosure provides a computer program product. The computer program product includes a computer program and the computer program, when executed by a processor, implements any image processing method of the present disclosure.

### BRIEF DESCRIPTION OF DRAWINGS

In combination with accompanying drawings and with reference to the following description of embodiments, the above and other features, advantages and aspects of the embodiments of the present disclosure will become more apparent. Throughout the accompanying drawings, a same or similar reference numeral represents a same or similar element. It should be understood that the accompanying drawings are illustrative and that the original and the element are not necessarily drawn to scale.

FIG. 1 is a schematic flowchart of an image processing method provided by an embodiment of the present disclosure;

FIG. 2 is an effect view of a filter image conversion node provided by an embodiment of the present disclosure;

FIG. 3 is an effect view of an image uploading node provided by an embodiment of the present disclosure;

FIG. 4 is a schematic flowchart of another image processing method provided by an embodiment of the present disclosure;

FIG. 5 is a schematic flowchart of another image processing method provided by an embodiment of the present disclosure;

FIG. 6 is a schematic structural diagram of an image processing apparatus provided by an embodiment of the present disclosure; and

FIG. 7 is a schematic structural diagram of an electronic device provided by an embodiment of the present disclosure.

### DETAILED DESCRIPTION

Hereinafter, the embodiments of the present disclosure will be described in more details with reference to the accompanying drawings. Although some embodiments of the present disclosure are illustrated in the drawings, it is to be understood that the present disclosure may be implemented through various forms, and may not be interpreted as being limited to the embodiments illustrated herein. On the contrary, these embodiments are only intended for a more thorough and complete understanding of the present disclosure. It is to be understood that the accompanying drawings and embodiments of the present disclosure are only for the purpose of illustration and are not intended to limit the protection scope of the present disclosure.

It should be understood that steps described in the embodiments of the present disclosure may be performed in different orders and/or performed in parallel. In addition, the method embodiments may include additional steps and/or omit performing of illustrated steps. The scope of the present disclosure is not limited thereto.

The term “including” and variations thereof adopted herein is inclusive, that is “including but not limited to”. The term “based on” means “at least partially based on”. The term “an embodiment” means “at least one embodiment”, and the term “another embodiment” means “at least another embodiment”. The term “some embodiment” means “at least some embodiments”. Definitions of other terms are provided below.

It should be noted that, the terms “first,” “second,” etc., mentioned in the present disclosure are only used to distinguish different apparatuses, modules or units, rather than limit an order or interdependence of functions performed by these apparatuses, modules or units.

It should be noted that, the terms “one” and “a plurality” mentioned in the present disclosure are illustrative rather than restrictive and should be understood as “one or more” by those skilled in the art, unless otherwise explicitly illustrated in the context.

Names of messages or information exchanged among multiple apparatuses in the embodiments of the present disclosure are merely used for illustrative purposes and are not used to limit the scope of these messages or information.

It is to be understood that before using technical solutions disclosed in various embodiments of the present disclosure, a user should be notified of the type, scope of use, use scene and the like of personal information involved in the present disclosure in an appropriate manner according to relevant laws and regulations, and authorization from the user should be acquired.

For example, in response to receiving an active request from a user, prompt information is sent to the user to explicitly remind the user that the requested operation requires acquisition and use of personal information of the user. Therefore, the user can independently choose, according to the prompt information, whether to provide personal information to software or hardware, such as an electronic device, an application program, a server, or a storage medium, etc., for executing operations of the technical solution of the present disclosure.

In an optional but non-limiting embodiment, in response to receiving the active request from the user, the manner in which the prompt information is sent to the user may be, for example, in the form of a pop-up window in which the prompt information may be presented in text. Additionally, the pop-up window may also carry a selection control for the user to select “agree” or “disagree” to determine whether to provide personal information to the electronic device.

It is to be understood that the preceding process of notifying the user and obtaining authorization from the user is illustrative only and does not limit the embodiments of the present disclosure, and that other manners complying with relevant laws and regulations may also be applied to the embodiments of the present disclosure.

It is to be understood that the data involved in the technical solution (including but not limited to the data itself, acquisition or use of the data) should comply with the requirements of corresponding laws, regulations and relevant rules.

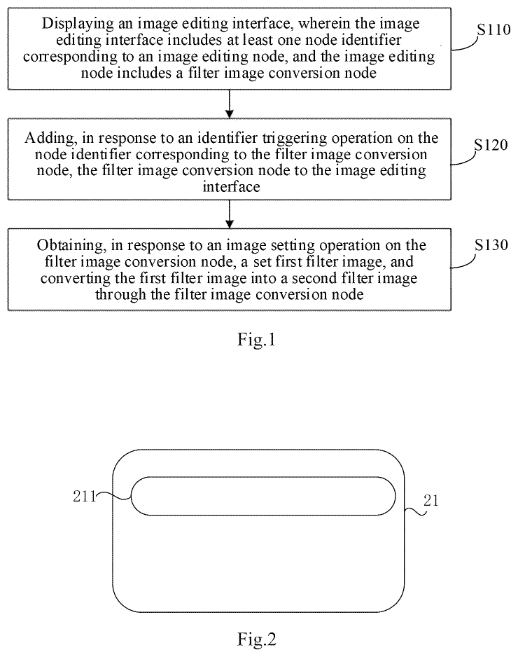

FIG. 1 is a schematic flowchart of an image processing method provided by an embodiment of the present disclosure. The embodiment of the present disclosure is applicable to the case of converting a filter image with a non-preset format into a filter image with a preset format. The method can be executed by an image processing apparatus. The apparatus can be implemented in the form of software and/or hardware, and optionally, can be implemented by an electronic device. The electronic device can be a mobile terminal, a PC terminal or a server, etc. As shown in FIG. 1, the method of the present embodiment can specifically include:
S110: Displaying an image editing interface, wherein the image editing interface includes at least one node identifier corresponding to an image editing node, and the image editing node includes a filter image conversion node.

The image editing interface can be a visual interface presented to the user terminal for image editing and/or presenting screen content. The image editing interface can be understood as a visual interface that supports the user to edit an image through a visual editing node. In the embodiment of the present disclosure, the image editing interface can provide an intuitive and easy-to-understand image editing environment for the user, and the image editing logic can be constructed by dragging-and-dropping and/or placing editing nodes. The image editing interface includes at least one node identifier corresponding to an image editing node. The image editing node can be understood as a visual component applied in a graphical editing environment, which can be used to perform an image editing operation. The image editing node can allow the user to construct a complete image editing logic by means of dragging-and-dropping and connecting. The node identifier can be information for identifying an image editing node. The node identifier can be information of any form, and optionally, can be text, number, English or graphic, etc. The image editing node can include a variety of editing nodes capable of performing image editing operations, and optionally, can include a filter image conversion node. The filter image conversion node can be a visual component for performing filter image conversion. In other words, a first filter image to be processed can be converted into a second filter image meeting the filter image requirements based on the filter image conversion node.

In the embodiment of the present disclosure, an image editing operation for triggering the display of an image editing interface can be set in advance. Furthermore, in the case where an image editing operation is detected, an image editing interface is displayed in response to the image editing operation, and the displayed image editing interface can include at least one node identifier corresponding to an image editing node, and the included image editing node can include a filter image conversion node. Furthermore, a corresponding image editing node can be added to the image editing interface based on the node identifier displayed in the image editing interface, so as to perform image editing based on the added image editing node. The image editing operation can be understood as an operation that triggers the execution of a subsequent image editing process. Optionally, the image editing operation can include at least one of the group consisting of the following: triggering a preset image editing control; receiving a preset image editing instruction; the received audio information including a trigger keyword associated with the image editing operation, etc.

As an optional implementation of the embodiment of the present disclosure, at least one image editing operation can be determined in advance, and the at least one image editing operation can include a filter image conversion operation. Then, an image editing node corresponding to each image editing operation can be determined, and the image editing node can include a filter image conversion node. And then, a node identifier corresponding to each image editing node can be determined, and the node identifier can be stored in association with the image editing node. Further, in the case where a triggering operation on the preset image editing control is detected, it is determined that an image editing operation is detected. Furthermore, in response to the image editing operation, an image editing interface is displayed. Further, at least one predetermined node identifier corresponding to the image editing node can be obtained, and the at least one node identifier can be displayed in the image editing interface.
S120: Adding, in response to an identifier triggering operation on the node identifier corresponding to the filter image conversion node, the filter image conversion node to the image editing interface.

In the embodiment of the present disclosure, there can be various ways to add an image editing node to the image editing interface and display the image editing node in the image editing interface. In order to facilitate the operation and reduce the operation difficulty, the image editing node to be added to the image editing interface can be determined by means of identifier selection.

The identifier triggering operation can be understood as an operation that is applied on a node identifier to make the node identifier in a triggered state. The identifier triggering operation can be an operation that triggers the selection of a node identifier. Optionally, the identifier triggering operation includes but is not limited to at least one of a click operation (including single-click and multiple-click), a long-press operation, a touch operation and a slide operation.

In the embodiment of the present disclosure, in the case where at least one node identifier corresponding to an image editing node is displayed in the image editing interface, a triggering operation can be input on the displayed node identifier, so as to add an image editing node corresponding to the triggered node identifier to the image editing interface. Furthermore, in the case where an identifier triggering operation on the node identifier corresponding to a filter image conversion node is detected, the filter image conversion node is added to the image editing interface in response to the identifier triggering operation, so that image editing can be performed in the image editing interface according to the added filter image conversion node.

In the embodiment of the present disclosure, there can be various ways to display at least one node identifier corresponding to the image editing node and the added image editing interface based on the image editing interface. In order to improve the clarity of displayed information and enhance the navigation and scalability of the interface, the image editing interface can be divided into a plurality of regions, and each region can be used to display different information. Optionally, the image editing interface can include an identifier display region and a visual editing region. The identifier display region can be used to display at least one node identifier corresponding to the image editing node. The identifier display region can be displayed in the image editing interface in any form, optionally, displayed in the form of a menu list, displayed in the form of a navigation bar and/or displayed in the form of a pop-up window, etc. The visual editing region can be used to display the added image editing node and to perform visual image editing based on the added image editing interface. The visual editing region can be any interface region other than the identifier display region in the image editing interface.

As an optional implementation of the embodiment of the present disclosure, in the case where an image editing operation is detected, an image editing interface is displayed in response to the image editing operation, and an identifier display region including at least one node identifier corresponding to an image editing node is displayed in the image editing interface; and an identifier triggering operation can be input on any node identifier displayed in the identifier display region to select the corresponding node identifier. Further, in the case where an identifier triggering operation on a node identifier corresponding to a filter image conversion node is detected, the filter image conversion node is obtained in response to the identifier triggering operation, and the obtained filter image conversion node is added to the visual editing region in the image editing interface, so that image editing can be performed in the visual editing region according to the added filter image conversion node.
S130: Obtaining, in response to an image setting operation on the filter image conversion node, a set first filter image, and converting the first filter image into a second filter image through the filter image conversion node. For example, the second filter image has a preset format.

The image setting operation can be understood as an operation used for setting an image to perform image editing. Optionally, the image setting operation can include an image uploading operation and/or an image drag-and-drop operation. In the embodiment of the present disclosure, the filter image conversion node can be an editing node used for performing a filter image conversion operation, and the image setting operation on the filter image conversion node can include an image setting operation that is directly applied on the filter image conversion node, or an image setting operation that is applied on an image uploading node associated with the filter image conversion node, etc. The first filter image can be a filter image to perform image editing. The first filter image can be an image capable of filtering any image. The first filter image can be an image obtained by applying the Look-Up Table (LUT) technology, and this image has been specially adjusted in color, contrast, saturation, exposure and other aspects to achieve a specific visual effect. It can be understood that LUT is essentially a data table, which defines the mapping between input data (usually color values) and output data (modified color values). When image processing is performed on the image to be processed based on the first filter image, the conversion of the color values of the image to be processed can be realized through the preset color mapping table contained in the first filter image. That is, the color values in the image to be processed can be replaced by the color defined in the first filter image by reading the color values in the first filter image, so as to achieve color correction or stylized effect. The first filter image can be a filter image in any format, and optionally, PNG or JPG, etc. The second filter image can be a filter image that meets the filter image requirements. The preset format can be any image format, optionally, RGB format, etc.

In the embodiment of the present disclosure, there can be various ways to obtain the set first filter image, optionally, including directly applying on the filter image conversion node to obtain the first filter image, or applying on the image uploading node in connection with the filter image conversion node to obtain the first filter image, etc. These various obtaining methods are respectively illustrated in the following.

In one obtaining method, the filter image conversion node includes a conversion image setting item; the obtaining, in response to an image setting operation on the filter image conversion node, a set first filter image, includes: obtaining, in response to an image setting operation on the conversion image setting item of the filter image conversion node, the set first filter image.

The conversion image setting item can be an operation entry that supports the user to input an image setting operation. Optionally, the image setting operation can include an image identifier selection operation, an image identifier editing operation, an image storage path selection operation and/or an image storage path editing operation.

In the embodiment of the present disclosure, an image setting operation can be input on the conversion image setting item included in the filter image conversion node. Furthermore, in the case where an image setting operation on the conversion image setting item is detected, the set first filter image can be obtained based on the image setting operation. The advantage of this setting is that the effect of obtaining the first filter image directly based on the filter image conversion node is realized, the convenience of setting the first filter image is enhanced, the operation difficulty of the filter image setting process is reduced, and further, the conversion efficiency of the filter image is improved.

As an optional implementation of the embodiment of the present disclosure, in the case where an image identifier display operation on the conversion image setting item is detected, at least one image identifier corresponding to a candidate filter image can be displayed based on the image identifier display region of the conversion image setting item. Further, in the case where an image identifier selection operation on any image identifier is detected, the candidate filter image corresponding to the selected image identifier can be obtained, and the candidate filter image can be taken as the first filter image, and the selected image identifier can be displayed based on the conversion image setting item.

As another optional implementation of the embodiment of the present disclosure, a conversion image setting item can be set in advance on the filter image conversion node. Furthermore, in the case where an image path editing operation on the conversion image setting item is detected, the conversion image setting item can be set to an editable state, that is, an image path can be input in the conversion image setting item. Further, in the case where a path editing completion operation is detected, the image path input in the conversion image setting item can be obtained, and a corresponding filter image can be obtained according to the image path, and the obtained filter image can be taken as the first filter image.

Illustratively, FIG. 2 is an effect view of a filter image conversion node provided by an embodiment of the present disclosure. As shown in FIG. 2, the filter image conversion node 21 includes a conversion image setting item 211. In the case where an image setting operation on the conversion image setting item 211 is detected, a set first filter image can be obtained, and the image identifier of the first filter image can be displayed in the conversion image setting item 211.

In another obtaining method, the image editing node includes an image uploading node; the obtaining, in response to an image setting operation on the filter image conversion node, a set first filter image, includes: in the case where the image uploading node includes a storage path setting item, obtaining, in response to a storage path setting operation on the storage path setting item of the image uploading node, an image stored in a set storage path as the first filter image.

The image uploading node can be a visual component for performing an image uploading operation. The storage path setting item can be understood as an operation entry that supports the user to set an image storage path. The storage path setting operation can be understood as an operation of setting an image storage path. Optionally, the storage path setting operation can include a storage path selection operation and/or a storage path editing operation. The storage path can be understood as a storage location of an image file in the computer system. That is, the required image can be located according to the storage path.

It should be noted that the image uploading node can be an editing node that is added to the image editing interface and can be in connection with the filter image conversion node.

In the embodiment of the present disclosure, the node identifier displayed in the image editing interface can include a node identifier corresponding to the image uploading node. Further, in the case where an identifier triggering operation on the node identifier corresponding to the image uploading node is detected, the image uploading node is added to the image editing interface in response to the identifier triggering operation, and the added image uploading node can include a storage path setting item set in advance. Further, a storage path setting operation can be input on the storage path setting item of the image uploading node. Further, in response to the storage path setting operation, a set storage path is determined, and a corresponding image is obtained according to the storage path. Furthermore, the obtained image can be taken as the first filter image.

As an optional implementation of the embodiment of the present disclosure, in the case where an image uploading node is added to the image editing interface and the added image uploading node includes a storage path setting item, a path display operation can be input on the storage path setting item. Furthermore, at least one candidate storage path can be displayed based on a path display region of the storage path setting item. Further, in the case where a path selection operation on any candidate storage path is detected, a selected candidate storage path can be determined, and this candidate storage path can be taken as the set storage path. Furthermore, a corresponding image can be obtained according to the storage path. Furthermore, the obtained image can be taken as the first filter image.

As another optional implementation of the embodiment of the present disclosure, in the case where an image uploading node is added to the image editing interface and the added image uploading node includes a storage path setting item, a storage path editing operation can be input on the storage path setting item, that is, an edited image storage path can be input in the storage path setting item based on the storage path editing operation. Further, in the case where a storage path editing operation on the storage path setting item is detected, the storage path setting item can be set to an editable state, and a storage path can be input in the storage path setting item. In the case where an editing completion operation is detected, the storage path input in the storage path setting item can be obtained, and this storage path can be taken as the set storage path. Furthermore, a corresponding image can be obtained according to the storage path. Furthermore, the obtained image can be taken as the first filter image.

In another obtaining method, in response to an image selection operation and an image drag-and-drop operation of dragging-and-dropping a selected image to a target node region of the image uploading node, the dragged-and-dropped image is determined as the first filter image, and the first filter image is displayed in association with the image uploading node.

The image selection operation can be an operation that is applied on any image to adjust the image from an unselected state to a selected state. In the embodiment of the present disclosure, at least one candidate filter image can be displayed. Furthermore, an image selection operation can be input on the at least one candidate filter image being displayed. Optionally, the candidate filter image can be displayed based on the image editing interface, or the candidate filter image can be displayed based on an image display interface different from the image editing interface, which is not specifically limited by the embodiment of the present disclosure. The image selection operation can include any operation that is applied on the candidate filter image, and optionally, includes but is not limited to at least one of a click operation (including single-click and multiple-click), a long-press operation and a touch operation. The target node region can be a node applied area associated with the image uploading node. The target node area can be a node editing region that can establish an association relationship with the image uploading node. Optionally, the target node region can be an editing region that can automatically establish an association relationship with the image uploading node; or the target node region can also be an editing region that establishes an association relationship with the image uploading node based on a node connection operation. The target node region can be an editing region constructed with the image uploading node as the center and a preset distance as the radius. The image drag-and-drop operation can specifically be an operation of selecting an image without dropping, and dragging the selected image to a preset position, and then dropping it.

In the embodiment of the present disclosure, at least one candidate filter image is displayed. Further, in the case where an image selection operation on any candidate filter image is detected, a selected image can be determined based on the image selection operation. Further, an image drag-and-drop operation can be input on the selected image to drag and drop the selected image to the target node region of the image uploading node based on the image drag-and-drop operation. In the case where the selected image is dragged and dropped to the target node region, this image can be taken as the first filter image, and an image node can be generated based on the first filter image, and this image node is connected with the image uploading node, so as to display the first filter image in association with the image uploading node.

In the embodiment of the present disclosure, in the case where the set first filter image is obtained, the first filter image can be converted into a second filter image through the filter image conversion node.

Optionally, the converting the first filter image into a second filter image through the filter image conversion node includes: parsing, through the filter image conversion node, the first filter image into a third filter image and creating a filter grid image with a second format, and writing a pixel color in the third filter image into the filter grid image to obtain the second filter image. For example, the third filter image has the preset format.

The third filter image can be a filter image which is obtained by parsing the first filter image and has an image format of a preset format. The second format can be a filter image file format being capable of performing filtering. The second format can be any image format, and optionally, is CUBE format. The filter grid image can be a grid image being capable of storing filter pixel color. The filter grid image can be a blank image composed of a plurality of uniform grid regions.

As an optional implementation of the embodiment of the present disclosure, in the case where the first filter image is obtained, a preset format to be converted can be set based on the filter image conversion node. Further, the filter image conversion node is executed to parse the first filter image into a third filter image with the preset format based on the filter image conversion node and the preset format, and the image size of the third filter image is obtained. Furthermore, a filter grid image with a second format can be created based on the obtained image size. Further, the pixel color of each pixel point in the third filter image can be read, and the pixel color that is read can be written into a corresponding pixel point in the filter grid image according to the pixel point mapping relationship. Furthermore, the filter grid image into which the pixel color has been written can be taken as the second filter image. The advantage of this setting is that it achieves the effect of converting a filter image with a non-preset format into a filter image with a preset format based on the filter image conversion node, simplifies the operation steps of the filter image processing procedure, and reduces the operation difficulty of the filter image processing procedure.

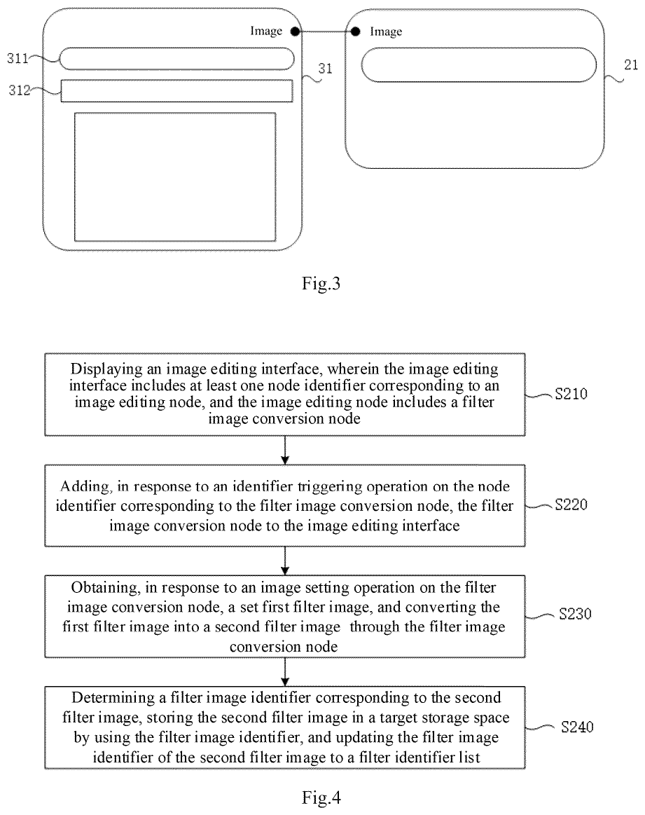

Illustratively, FIG. 3 is an effect view of an image uploading node provided by an embodiment of the present disclosure. As shown in FIG. 3, the image uploading node 31 includes a storage path setting item 311 and an upload control 312. In the case where a storage path setting operation on the storage path setting item 311 is detected, a storage path of the first filter image can be set based on the storage path setting item 311, and the set storage path can be displayed in the storage path setting item 311. Further, in the case where a triggering operation on the upload control is detected, according to the set storage path, the filter image in this path can be retrieved, and the retrieved filter image is taken as the first filter image 313, and the first filter image 313 is displayed in the image uploading node 31. Further, the image uploading node 31 can be connected with the filter image conversion node 21. Furthermore, in the case where a node running operation on the filter image conversion node 21 is detected, the first filter image 313 can be obtained from the image uploading node 31 based on the filter image conversion node 21. Furthermore, the first filter image can be converted into a second filter image with the preset format through the filter image conversion node 21.

According to the technical solution of the embodiment of the present disclosure, an image editing interface is displayed, wherein the image editing interface includes at least one node identifier corresponding to an image editing node, and the image editing node includes a filter image conversion node, so that the filter image processing procedure can be visually presented, and the subsequent image processing operation is facilitated; further, in response to an identifier triggering operation on the node identifier corresponding to the filter image conversion node, the filter image conversion node is added to the image editing interface, so that it can add the filter image conversion node to the image editing interface through a simple interactive operation, reduces the operation difficulty of the filter image processing procedure, and supports the filter image processing flow in the visual image editing interface; further, in response to an image setting operation on the filter image conversion node, a set first filter image is obtained, and the first filter image is converted into a second filter image with a preset format through the filter image conversion node, thus solving the technical problem that the image processing method is cumbersome, complicated, laborious and inefficient, and realizing the visual presentation of the filter image processing procedure. And the first filter image to be processed can be converted into a second filter image with a preset format through a simple interactive operation, so that the operation steps of the filter image processing procedure are simplified, the operation difficulty of the filter image processing procedure is reduced, and further, the application efficiency of filter effect is improved.

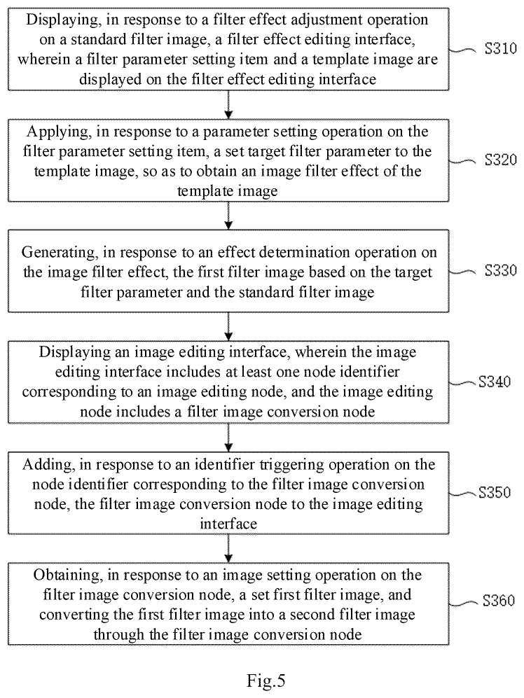

FIG. 4 is a schematic flowchart of another image processing method provided by an embodiment of the present disclosure. On the basis of the above embodiment, after the converting the first filter image into a second filter image through the filter image conversion node, the technical solution of the present embodiment further includes: determining a filter image identifier corresponding to the second filter image, storing the second filter image in a target storage space by using the filter image identifier, and updating the filter image identifier of the second filter image to a filter identifier list. Specific implementations can be found in the description of the present embodiment. The technical features same to or similar as those in the above embodiment will not be repeated here. As shown in FIG. 4, the method in the present embodiment can specifically include:
S210: Displaying an image editing interface, wherein the image editing interface includes at least one node identifier corresponding to an image editing node, and the image editing node includes a filter image conversion node.
S220: Adding, in response to an identifier triggering operation on the node identifier corresponding to the filter image conversion node, the filter image conversion node to the image editing interface.
S230: Obtaining, in response to an image setting operation on the filter image conversion node, a set first filter image, and converting the first filter image into a second filter image through the filter image conversion node. For example, the second filter image has a preset format.
S240: Determining a filter image identifier corresponding to the second filter image, storing the second filter image in a target storage space by using the filter image identifier, and updating the filter image identifier of the second filter image to a filter identifier list.

The filter image identifier can be information for identifying a filter image. The filter image identifier can be information of any form, and optionally, can be text, number, English or graphic, etc. The target storage space can be a storage space associated with the related application software, that is, a storage space that can be accessed by the related application software. Illustratively, the target storage space can be an image library in the application software or a local terminal photo album, etc. The filter identifier list can be understood as a collection for storing filter image identifiers. The filter identifier list includes a filter image identifier corresponding to a candidate filter image with the preset format. The candidate filter image can be a filter image to be selected to perform a filter processing operation. The candidate filter image can include a filter image obtained by conversion using the filter image conversion node and/or a filter image obtained by conversion using any other image conversion method. It should be noted that after the filter image identifier of the second filter image is updated to the filter image identifier list, the candidate filter image included in the filter image identifier list also include the second filter image. It should also be noted that the filter image identifiers included in the filter image identifier list can be sorted according to a preset identifier sorting standard. The preset identifier sorting standard can be any sorting standard, and optionally, it is sorting according to the identifier updating time or sorting according to the identifier name of the filter image identifier.

In the embodiment of the present disclosure, there can be at least two ways to determine the filter image identifier corresponding to the second filter image. Optionally, a filter image identifier of the first filter image corresponding to the second filter image is obtained, and this filter image identifier is taken as the filter image identifier corresponding to the second filter image; or in response to an identifier editing operation, an edited filter image identifier is determined based on the identifier editing operation, and the edited filter image identifier is taken as the filter image identifier corresponding to the second filter image, and so on.

As an optional implementation of the embodiment of the present disclosure, the filter image conversion node can include a filter image storage item, and an image identifier editing operation can be input on the filter image storage item. Furthermore, in the case where an image identifier editing operation on the filter image storage item is detected, an edited image identifier is determined based on the image identifier editing operation. Furthermore, in the case where a second filter image with the preset format is obtained through the filter image conversion node, the edited image identifier can be taken as the filter image identifier corresponding to the second filter image. Further, the second filter image can be stored in the target storage space by using the filter image identifier, so that the second filter image is stored in the target storage space and is in association with the filter image identifier. Moreover, the filter image identifier of the second filter image can be updated to the filter identifier list.

In the embodiment of the present disclosure, after the second filter image is stored in the target storage space and the filter image identifier is updated to the filter identification list, the filter image identifier of the candidate filter image to be filtered can be determined based on the filter identifier list. Furthermore, a corresponding candidate filter image can be retrieved from the target storage space based on the selected filter image identifier, and the filter processing can be performed based on the retrieved candidate filter image.

It should be noted that the candidate filter images can be applied in various ways. In order to facilitate the operation, reduce the operation difficulty, and perform visual presentation on the filter application logic, the candidate filter image can be applied by adding an image editing node associated with the filter application operation in the image editing interface.

Optionally, the image editing node includes a filter image application node, and the filter image application node includes an application image setting item and a filter image setting item; after the updating the filter image identifier of the second filter image to a filter identifier list, the image processing method further includes: obtaining, in response to an image setting operation on the application image setting item of the filter image application node, an image to be processed; and displaying, in response to an image setting operation on the filter image setting item of the filter image application node, the filter identifier list; determining, in response to an identifier triggering operation on the filter image identifier in the filter identifier list, a target filter image in the candidate filter image according to the triggered filter image identifier, and filtering the image to be processed through the target filter image, so as to obtain a filter effect image. The advantage of this setting is that the visual presentation of the filter image application process is realized, and the target filter image to be applied can be determined through a simple interactive operation, so that the target filter image can perform filtering on the image to be processed, that is, the effect of applying the applicable filter image to the image to be processed on the image editing interface is realized, and the filter processing efficiency is improved.

The filter image application node can be a visual component for performing a filter image application operation. The application image setting item can be an operation entry that supports the user to set an image to be filtered. The image setting operation on the application image setting item can be any operation applied on the application image setting item, and optionally, can include an image uploading operation and/or an image retrieval operation. The image to be processed can be an image to be filtered. The image to be processed can be any image that needs filter processing, and optionally, can be an image obtained after processing based on an effect processing node, or an original image without any effect processing, or a template image set in advance, etc. The effect processing node can be a visual component for performing an effect processing operation. Optionally, the effect processing operation can include an operation of generating target data through a data processing model and/or an operation of generating target data through a data processing algorithm, etc. The data processing model can be a deep learning model that is pre-trained and deployed on a server and is used for effect data processing to generate target data. The data processing model can include a variety of models capable of performing effect processing on data to generate target data, and optionally, can include at least one of an image processing model, an image generation model and a dialogue generation model.

The filter image setting item can be an operation entry that supports the user to set a filter image to perform the filter processing operation. The target filter image can be a candidate filter image corresponding to a triggered filter image identifier. The filter effect image can be an image obtained by filtering the image to be processed based on the target filter image, so that the processed image to be processed presents a filter effect corresponding to the target filter image.

In the embodiment of the present disclosure, there can be various display modes of the filter identifier list. Optionally, the filter identifier list can be displayed in the identifier display region of the filter image setting item in the form of a drop-down list, or displayed on the image editing interface in the form of a pop-up window, or displayed on the image editing interface in the form of a side menu bar, etc.

As an optional implementation of the embodiment of the present disclosure, the image editing interface can include an effect processing node, and the effect processing node can be connected with the application image setting item of the filter image application node. Furthermore, in the case where an image setting operation on the application image setting item is detected, an effect image output by the effect processing node can be obtained based on the filter image application node, and the effect image can be taken as the image to be processed. And in the case where an image setting operation on the filter image setting item of the filter image application node is detected, a filter identifier list can be obtained, and the filter identifier list can be displayed in the identifier display region of the filter image setting item in the form of a drop-down list, and the displayed filter identifier list includes a filter image identifier corresponding to at least one candidate filter image. Further, in the case where an identifier triggering operation on any filter image identifier in the filter identifier list is detected, a candidate filter image corresponding to the triggered filter image identifier can be taken as a target filter image, and the target filter image can be retrieved from the target storage space according to the triggered filter image identifier. Further, the image to be processed can be filtered according to the target filter image through the filter image application node, and the image to be processed, after being filtered, can be taken as the filter effect image.

In practical application, in the case where the image to be processed is filtered through the target filter image, there may be cases where the filter processing degree of the obtained filter effect image is too low or too high, which does not meet the preset filter processing requirements.

In view of the above situation, in the embodiment of the present disclosure, the filter image application node further includes a filter degree setting item; after the displaying an image editing interface, the image processing method further includes: obtaining, in response to a filter degree setting operation on the filter degree setting item of the filter image application node, a set filter degree parameter. The advantage of this setting is that the effect of customizing the filter degree is realized, and the flexibility of the filter processing procedure is enhanced. Moreover, by setting the filter degree parameter, the adaptability between the filter effect and the user is enhanced.

The filter degree setting item can be understood as an operation entry that supports the user to set the filter degree parameter. The filter degree setting operation can be understood as an operation for setting the filter degree parameter. Optionally, the filter degree setting operation can include a filter degree parameter selection operation and/or a filter degree parameter editing operation, etc. The filter degree parameter can be a numerical value used to adjust the filter intensity or effect during the filter processing procedure. During the filter processing procedure, the image to be processed is finely adjusted based on the filter degree parameter, so that the filter effect of the filter effect image can reach the desired filter effect.

As an optional implementation of the embodiment of the present disclosure, in the case where a filter degree setting operation on the filter degree setting item of the filter image application node is detected, at least one candidate filter degree parameter is displayed. Further, in the case where a parameter triggering operation on any filter degree parameter is detected, the filter degree parameter can be taken as the set filter degree parameter.

As another optional implementation of the embodiment of the present disclosure, in the case where a filter degree setting operation on the filter degree setting item of the filter image application node is detected, the filter degree setting item can be adjusted to an editable input state, and a filter degree parameter can be input in the filter degree setting item based on the filter degree editing operation. Further, in the case where an editing completion operation is detected, the filter degree parameter input in the filter degree setting item can be obtained and taken as the set filter degree parameter.

In the embodiment of the present disclosure, in the case where the filter degree parameter set in advance is obtained, the image to be processed can be filtered based on the filter degree parameter and the target filter image.

Optionally, the filtering the image to be processed through the target filter image includes: filtering the image to be processed through the set filter degree parameter and the target filter image.

As an optional implementation of the embodiment of the present disclosure, in the case where the set filter degree parameter and the target filter image are obtained, the image to be processed can be filtered based on the target filter image, and the filter processing intensity and/or filter processing effect can be adjusted according to the set filter degree parameter. Furthermore, a filter effect image that meets the desired filter effect can be obtained. The advantage of this setting is that the effect of custom adjustment of the filter effect is realized, and further, the flexibility of the filter processing procedure is enhanced, and the effect of obtaining filter effect images matched with different users based on the same target filter image is realized.

According to the technical solution of the embodiment of the present disclosure, after the converting the first filter image into a second filter image through the filter image conversion node, a filter image identifier corresponding to the second filter image is determined, the second filter image is stored in a target storage space by using the filter image identifier, and the filter image identifier of the second filter image is updated to a filter identifier list, so that the effect of storing the filter image obtained through conversion and updating the filter image identifier to a preset identifier list is achieved through a simple interactive operation, and the steps of storing the filter image and updating the filter identifier are simplified, and further, the application convenience of the filter image is enhanced and the application efficiency of the filter image is improved.

FIG. 5 is a schematic flowchart of another image processing method provided by an embodiment of the present disclosure. According to the technical solution of the present embodiment, on the basis of the above embodiments, before the obtaining a set first filter image, the first filter image can be generated. Furthermore, image processing can be performed based on the generated first filter image. Specific implementations can be found in the description of the present embodiment. The technical features same to or similar as those in the above embodiment will not be repeated here. As shown in FIG. 5, the method in the present embodiment can specifically include:
S310: Displaying, in response to a filter effect adjustment operation on a standard filter image, a filter effect editing interface, wherein a filter parameter setting item and a template image are displayed on the filter effect editing interface.

The standard filter image can be understood as a pre-generated filter image with a standard format and containing at least one filter effect or color. Illustratively, the standard filter image can be a filter color card with an 8×8 filter grid, 512×512 pixels and a format of PNG or JPG. In the embodiment of the present disclosure, in order to simplify the generation procedure of the first filter image and reduce the operation difficulty of the generation procedure of the first filter image, the first filter image can be generated by using the standard filter image, that is, the first filter image that meets the requirements can be obtained by adjusting the filter effect of the standard filter image. The filter effect adjustment operation can be understood as an operation for adjusting the filter effect of the filter image. The filter effect adjustment operation can be any operation applied on the standard filter image, and optionally, can be a click operation (including single-click or double-click) applied on the standard filter image, or a selection operation on the filter effect editing item of the standard filter image, etc. The filter effect editing interface can be a visual interface presented to the client for editing the filter effect and/or presenting the filter effect. The filter parameter setting item can be understood as an operation entry that supports the user to set the filter parameter. The filter parameter setting item can include setting items corresponding to various filter parameters, and optionally, can include at least one of a color balance parameter setting item, a color temperature parameter setting item, a hue parameter setting item, a saturation parameter setting item, an exposure parameter setting item and a contrast parameter setting item. The template image can be a preset image for displaying the filter parameter adjustment effect. It should be noted that in order to compare the effects of the standard filter image before adjustment and after adjustment more clearly and intuitively based on the template image, the template image displayed on the filter effect interface can be an image obtained by applying the standard filter image to any image, that is, the template image can present a filter effect corresponding to the standard filter image. In other words, the template image displayed on the filter effect editing interface can be a filter effect image corresponding to the standard filter image.

In the embodiment of the present disclosure, a standard filter image can be obtained, and the obtained standard filter image can be displayed based on the image editing interface. Further, in the case where a filter effect adjustment operation on the standard filter image is detected, a filter effect editing interface is displayed in response to the filter effect adjustment operation, and the filter effect editing interface can display a filter parameter setting item and a template image corresponding to the standard filter image.

As an optional implementation of the embodiment of the present disclosure, in the case where the standard filter image is displayed based on the image editing interface, an image triggering operation can be input on the standard filter image. Furthermore, in the case where the image triggering operation on the standard filter image is detected, it is determined that a filter effect adjustment operation is detected. Furthermore, in response to the filter effect adjustment operation, a filter effect editing interface is displayed.
S320: Applying, in response to a parameter setting operation on the filter parameter setting item, a set target filter parameter to the template image, so as to obtain an image filter effect of the template image.

The parameter setting operation can be understood as an operation of setting a filter parameter based on the filter parameter setting item. Optionally, the parameter setting operation can include a parameter selection operation, a parameter editing operation and/or a parameter adjustment operation, etc. It should be noted that the filter parameter setting item can be used to display a filter parameter, and in the case where a parameter setting operation is not input on the filter parameter setting item, the filter parameter displayed by the filter parameter setting item can be a filter parameter associated with the standard filter parameter. The target filter parameter can be a filter parameter obtained after performing parameter setting on the filter parameter setting item. The target filter parameter can include a filter parameter corresponding to at least one filter parameter setting item.

In the embodiment of the present disclosure, in the case where the filter effect editing interface includes a filter parameter setting item, in order to adjust the filter effect corresponding to the standard filter image, a parameter setting operation can be input on the filter parameter setting item. Furthermore, a set target filter parameter can be determined based on the parameter setting operation. Further, the set target filter parameter can be applied to the template image, so as to obtain the image filter effect of the template image.

As an optional implementation of the embodiment of the present disclosure, in the case where a parameter setting operation on the filter parameter setting item is detected, at least one candidate filter parameter can be displayed. Further, in the case where a parameter selection operation on the candidate filter parameter is detected, the selected candidate filter parameter can be taken as a filter parameter corresponding to the filter parameter setting item, and this filter parameter can be displayed in the filter parameter setting item. Further, in the case where a setting completion operation is detected, the filter parameters displayed in the filter parameter setting items can be obtained, and these filter parameters can be taken as the set target filter parameters.

As another optional implementation of the embodiment of the present disclosure, the filter parameter setting item displayed in the filter effect editing interface can be in the form of an adjustment axis control. In this case, the parameter corresponding to the point where the pointer stays on the adjustment axis is the filter parameter corresponding to the standard filter parameter. Further, the pointer on the adjustment axis can be controlled to slide on the adjustment axis based on an input device, and the parameter corresponding to the point where the pointer stays on the adjustment axis can be taken as the filter parameter corresponding to the filter parameter setting item. Further, in the case where a setting completion operation is detected, the filter parameters corresponding to the pointers in the filter parameter setting items can be obtained, and these filter parameters can be taken as the set target filter parameters.
S330: Generating, in response to an effect determination operation on the image filter effect, the first filter image based on the target filter parameter and the standard filter image.

The effect determination operation can be an operation for determining the image filter effect displayed in the interface. Optionally, the effect determination operation can include at least one of the group consisting of the following: triggering a preset effect determination control; receiving a preset effect determination instruction; the received audio information including trigger keywords associated with the effect determination operation, and so on.

In the embodiment of the present disclosure, in the case where an effect determination operation on the image filter effect is detected, the target filter parameter corresponding to the image filter effect is obtained in response to the effect determination operation. Further, the standard filter image can be adjusted based on the target filter parameter, and the filter image obtained after adjustment can be taken as the first filter image.
S340: Displaying an image editing interface, wherein the image editing interface includes at least one node identifier corresponding to an image editing node, and the image editing node includes a filter image conversion node.
S350: Adding, in response to an identifier triggering operation on the node identifier corresponding to the filter image conversion node, the filter image conversion node to the image editing interface.
S360: Obtaining, in response to an image setting operation on the filter image conversion node, a set first filter image, and converting the first filter image into a second filter image through the filter image conversion node. For example, the second filter image has a preset format.

It should be noted that in the embodiment of the present disclosure, in the case where the filter effect corresponding to the obtained second filter image does not meet the preset filter effect requirements, the first filter image corresponding to the second filter image can also be taken as the standard filter image, and steps S310-S330 can be executed to adjust the filter effect of the standard filter image and the adjusted first filter image can be obtained. Furthermore, the adjusted first filter image can be converted into a second filter image with the preset format through the filter image conversion node.

According to the technical solution of the embodiment of the present disclosure, in response to a filter effect adjustment operation on a standard filter image, a filter effect editing interface is displayed, wherein a filter parameter setting item and a template image are displayed on the filter effect editing interface; further, in response to a parameter setting operation on the filter parameter setting item, a set target filter parameter is applied to the template image, so as to obtain an image filter effect of the template image; further, in response to an effect determination operation on the image filter effect, a first filter image is generated based on the target filter parameter and the standard filter image, so that the effect of performing filter effect adjustment on the standard filter image to obtain the first filter image to be format-converted is achieved. The filter image generation process and the filter image conversion process are integrated into the same production tool, which improves the processing convenience of the filter image, improves the processing efficiency of the filter image, and improves the filter image processing experience.

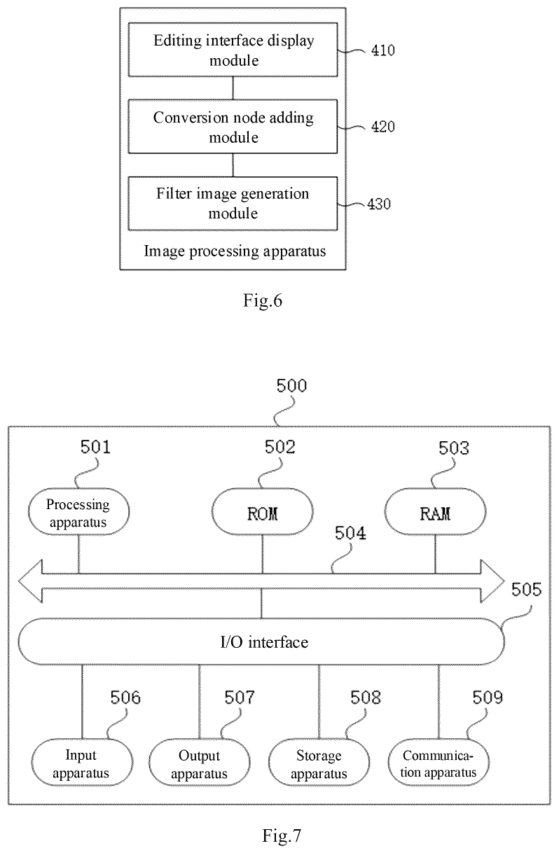

FIG. 6 is a schematic structural diagram of an image processing apparatus provided by an embodiment of the present disclosure. As shown in FIG. 6, the apparatus includes an editing interface display module 410, a conversion node adding module 420 and a filter image generation module 430.

The editing interface display module 410 is configured to display an image editing interface, wherein the image editing interface includes at least one node identifier corresponding to an image editing node, and the image editing node includes a filter image conversion node; the conversion node adding module 420 is configured to add, in response to an identifier triggering operation on the node identifier corresponding to the filter image conversion node, the filter image conversion node to the image editing interface; the filter image generation module 430 is configured to obtain, in response to an image setting operation on the filter image conversion node, a set first filter image, and to convert the first filter image into a second filter image through the filter image conversion node. For example, the second filter image has a preset format.

According to the technical solution of the embodiment of the present disclosure, the image editing interface is displayed through the editing interface display module 410, wherein the image editing interface includes at least one node identifier corresponding to an image editing node, and the image editing node includes a filter image conversion node, so that the filter image processing procedure can be visually presented, and the subsequent image processing operation is facilitated; further, through the conversion node adding module 420, in response to an identifier triggering operation on the node identifier corresponding to the filter image conversion node, the filter image conversion node is added to the image editing interface, so that it can add the filter image conversion node to the image editing interface through a simple interactive operation, reduces the operation difficulty of the filter image processing procedure, and supports the filter image processing process in the visual image editing interface; further, through the filter image generation module 430, in response to an image setting operation on the filter image conversion node, a set first filter image is obtained, and the first filter image is converted into a second filter image with a preset format through the filter image conversion node, thus solving the technical problem that the image processing method is cumbersome, complicated, laborious and inefficient, and realizing the visual presentation of the filter image processing procedure. And the first filter image to be processed can be converted into a second filter image with a preset format through a simple interactive operation, so that the operation steps of the filter image processing procedure are simplified, the operation difficulty of the filter image processing procedure is reduced, and further, the processing efficiency of filter effect is improved.

On the basis of any optional technical solution described above, optionally, the apparatus further includes an image storage module. The image storage module is configured, after the converting the first filter image into a second filter image through the filter image conversion node, to determine a filter image identifier corresponding to the second filter image, store the second filter image in a target storage space by using the filter image identifier, and update the filter image identifier of the second filter image to a filter identifier list, wherein the filter identifier list includes a filter image identifier corresponding to a candidate filter image.

On the basis of any optional technical solution described above, optionally, the image editing node includes a filter image application node, the filter image application node includes an application image setting item and a filter image setting item; the apparatus further includes an image obtaining module and a filter processing module. The image obtaining module is configured, after the updating the filter image identifier of the second filter image to a filter identifier list, to obtain, in response to an image setting operation on the application image setting item of the filter image application node, an image to be processed, and display, in response to an image setting operation on the filter image setting item of the filter image application node, the filter identifier list; the filter processing module is configure to determine, in response to an identifier triggering operation on the filter image identifier in the filter identifier list, a target filter image in the candidate filter image according to the triggered filter image identifier, and filter the image to be processed through the target filter image, so as to obtain a filter effect image.

On the basis of any optional technical solution described above, optionally, the filter image application node further includes a filter degree setting item; the apparatus further includes a filter degree setting module. The filter degree setting module is configured, after the displaying an image editing interface, to obtain, in response to a filter degree setting operation on the filter degree setting item of the filter image application node, a set filter degree parameter; and the filter processing module is specifically configured to filter the image to be processed through the set filter degree parameter and the target filter image.

On the basis of any optional technical solution described above, optionally, the filter image conversion node includes a conversion image setting item; the filter image generation module 430 includes an image setting unit. The image setting unit is configured to obtain, in response to an image setting operation on the conversion image setting item of the filter image conversion node, the set first filter image.

On the basis of any optional technical solution described above, optionally, the image editing node includes an image uploading node; the filter image generation module 430 includes a storage path setting unit or an image drag-and-drop unit. The storage path setting unit is configured, in a case where the image uploading node includes a storage path setting item, to obtain, in response to a storage path setting operation on the storage path setting item of the image uploading node, an image stored in a set storage path as the first filter image; or the image drag-and-drop unit is configured to determine, in response to an image selection operation and an image drag-and-drop operation of dragging-and-dropping a selected image to a target node region of the image uploading node, the dragged-and-dropped image as the first filter image, and display the first filter image in association with the image uploading node.

On the basis of any optional technical solution described above, optionally, the filter image generation module 430 includes a filter image generation unit. The filter image generation unit is configured to parse, through the filter image conversion node, the first filter image into a third filter image t and create a filter grid image with a second format, and write a pixel color in the third filter image into the filter grid image to obtain the second filter image. For example, the third filter image has the preset format.

On the basis of any optional technical solution described above, optionally, the apparatus further includes a filter editing interface display module, a filter parameter determining module and a first filter image determining module. The filter editing interface display module is configured, before the obtaining a set first filter image, to display, in response to a filter effect adjustment operation on a standard filter image, a filter effect editing interface, wherein a filter parameter setting item and a template image are displayed on the filter effect editing interface; the filter parameter determining module is configured to apply, in response to a parameter setting operation on the filter parameter setting item, a set target filter parameter to the template image, so as to obtain an image filter effect of the template image; and the first filter image determining module is configured to generate, in response to an effect determination operation on the image filter effect, the first filter image based on the target filter parameter and the standard filter image.

The image processing apparatus provided by the embodiment of the present disclosure can execute the image processing method provided by any embodiment of the present disclosure, and has corresponding functional modules for executing the method and corresponding beneficial effects.

It is to be noted that units and modules included in the preceding apparatus are just divided according to functional logic, and the division is not limited thereto, provided that the corresponding functions can be implemented. Additionally, the specific names of the units and modules are just intended for distinguishing, and are not intended to limit the protection scope of the embodiments of the present disclosure.

FIG. 7 is a schematic structural diagram of an electronic device provided by an embodiment of the present disclosure. Hereinafter, referring to FIG. 7, it shows a schematic structural diagram of an electronic device 500 (e.g., a terminal device or server in FIG. 7) suitable for implementing the embodiment of the present disclosure. The terminal device in the embodiment of the present disclosure can include, but is not limited to, a mobile terminal such as a mobile phone, a laptop computer, a digital broadcast receiver, a personal digital assistant (PDA), a portable android device (PAD), a portable media player (PMP), a vehicle-mounted terminal (e.g., vehicle-mounted navigation terminal), etc., and a fixed terminal such as a digital television (TV), a desktop computer, etc. The electronic device shown in FIG. 7 is merely an example, and should not bring any limitation to the function and application scope of the embodiment of the present disclosure.

As shown in FIG. 7, the electronic device 500 can include a processing apparatus (e.g., central processing unit, graphics processing unit, etc.) 501, which can execute various suitable actions and processes according to a program stored in a read-only memory (ROM) 502 or a program loaded from a storage apparatus 508 into a random access memory (RAM) 503. In the RAM 503, various programs and data necessary for the operations of the electronic device 500 are also stored. The processing apparatus 501, the ROM 502, and the RAM 503 are connected to each other through a bus 504. An input/output (I/O) interface 505 is also connected to the bus 704.

Generally, the following apparatuses can be connected to the I/O interface 505: an input apparatus 506 including, for example, a touch screen, a touch pad, a keyboard, a mouse, a camera, a microphone, an accelerometer, a gyroscope, etc.; an output apparatus 507 including, for example, a liquid crystal display (LCD), a speaker, a vibrator, etc.; a storage apparatus 508 including, for example, a magnetic tape, a hard disk, etc.; and a communication apparatus 509. The communication apparatus 509 can allow the electronic device 500 to perform wireless or wired communication with another device to exchange data. While FIG. 7 illustrates the electronic device 500 with various apparatuses, it should be understood that all illustrated apparatuses are not required to be implemented or provided. More or fewer apparatuses can be alternatively implemented or provided.

In particular, according to the embodiment of the present disclosure, the process described above with reference to the flowcharts can be implemented as a computer software program. For example, an embodiment of the present disclosure provides a computer program product including a computer program carried on a non-transitory computer-readable medium, and the computer program contains program codes for performing the method illustrated by the flowcharts. In such an embodiment, the computer program can be downloaded and installed from a network via the communication apparatus 509, or installed from the storage apparatus 508, or installed from the ROM 502. When executed by the processing apparatus 501, the computer program performs the above functions defined in the method according to the embodiment of the present disclosure.

Names of messages or information exchanged among multiple apparatuses in the embodiments of the present disclosure are merely used for illustrative purposes, and are not used to limit the scope of these messages or information.

The electronic device provided by the embodiment of the present disclosure belongs to the same inventive concept as the image processing method provided by the above embodiments, and the technical details not provided in the present embodiment can be found in the above embodiments, and the present embodiment has the same beneficial effects as the above embodiments.

An embodiment of the present disclosure provides a computer storage medium, on which a computer program is stored; when the computer program is executed by a processor, the image processing method provided by the above embodiments is implemented.

It should be noted that the above computer-readable medium of the present disclosure can be a computer-readable signal medium or a computer-readable storage medium or any combination thereof. The computer-readable storage medium can be, for example, but not limited to, an electronic, magnetic, optical, electromagnetic, infrared, or semiconductor system, apparatus, or device, or any combination of the above. More specific examples of the computer-readable storage medium can include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium can be any tangible medium containing or storing a program, wherein the program can be used by or in conjunction with an instruction execution system, apparatus, or device. However, in the present disclosure, the computer-readable signal medium can include a data signal propagated in baseband or as part of a carrier wave, in which computer-readable program code is carried. Such a propagated data signal can take a variety of forms, including but not limited to an electro-magnetic signal, an optical signal, or any suitable combination of the above. The computer-readable signal medium can be any computer-readable medium other than the computer-readable storage medium, and the computer-readable signal medium can send, propagate, or transmit a program for use by or in conjunction with an instruction execution system, apparatus, or device. Program codes contained on the computer-readable medium can be transmitted using any suitable medium, including but not limited to: an electrical wire, an optical cable, RF (radio frequency), etc., or any suitable combination of the above.

In some implementations, a client and a server can communicate using any currently known or future developed network protocol, such as HTTP (Hyper Text Transfer Protocol), etc., and can be interconnected with any form or medium of digital data communication (e.g., a communication network). Examples of the communication network include a local area network (“LAN”), a wide area network (“WAN”), an internet (e.g., the Internet), and a peer-to-peer network (e.g., ad hoc peer-to-peer network), as well as any currently known or future developed network.

The above computer-readable medium may be contained in the above electronic device; or may also exist alone without being assembled into the electronic device.

The above computer-readable medium has thereon carried one or more programs which, when executed by the electronic device, cause the electronic device to: display an image editing interface, wherein the image editing interface includes at least one node identifier corresponding to an image editing node, and the image editing node includes a filter image conversion node; add, in response to an identifier triggering operation on the node identifier corresponding to the filter image conversion node, the filter image conversion node to the image editing interface; obtain, in response to an image setting operation on the filter image conversion node, a set first filter image, and convert the first filter image into a second filter image through the filter image conversion node.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the editing interface display module also can be described as “the module for displaying image edit interface.”

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, [Example 1] provides an image processing method, which includes: displaying an image editing interface, wherein the image editing interface includes at least one node identifier corresponding to an image editing node, and the image editing node includes a filter image conversion node; adding, in response to an identifier triggering operation on the node identifier corresponding to the filter image conversion node, the filter image conversion node to the image editing interface; obtaining, in response to an image setting operation on the filter image conversion node, a set first filter image, and converting the first filter image into a second filter image through the filter image conversion node.

According to one or more embodiments of the present disclosure, [Example 2] provides the method of Example 1, further including: optionally, after the converting the first filter image into a second filter image through the filter image conversion node, the method further includes: determining a filter image identifier corresponding to the second filter image, storing the second filter image in a target storage space by using the filter image identifier, and updating the filter image identifier of the second filter image to a filter identifier list, wherein the filter identifier list includes a filter image identifier corresponding to a candidate filter image.

According to one or more embodiments of the present disclosure, [Example 3] provides the method of Example 2, further including: optionally, the image editing node includes a filter image application node, the filter image application node includes an application image setting item and a filter image setting item; after the updating the filter image identifier of the second filter image to a filter identifier list, the method further includes: obtaining, in response to an image setting operation on the application image setting item of the filter image application node, an image to be processed; and displaying, in response to an image setting operation on the filter image setting item of the filter image application node, the filter identifier list; determining, in response to an identifier triggering operation on the filter image identifier in the filter identifier list, a target filter image in the candidate filter image according to the triggered filter image identifier, and filtering the image to be processed through the target filter image, so as to obtain a filter effect image.

According to one or more embodiments of the present disclosure, [Example 4] provides the method of Example 3, further including: optionally, the filter image application node further includes a filter degree setting item; after the displaying an image editing interface, the method further includes: obtaining, in response to a filter degree setting operation on the filter degree setting item of the filter image application node, a set filter degree parameter; the filtering the image to be processed through the target filter image includes: filtering the image to be processed through the set filter degree parameter and the target filter image.

According to one or more embodiments of the present disclosure, [Example 5] provides the method of Example 1, further including: optionally, the filter image conversion node includes a conversion image setting item; the obtaining, in response to an image setting operation on the filter image conversion node, a set first filter image, includes: obtaining, in response to an image setting operation on the conversion image setting item of the filter image conversion node, the set first filter image.

According to one or more embodiments of the present disclosure, [Example 6] provides the method of Example 1, further including: optionally, the image editing node includes an image uploading node; the obtaining, in response to an image setting operation on the filter image conversion node, a set first filter image, includes: in a case where the image uploading node includes a storage path setting item, obtaining, in response to a storage path setting operation on the storage path setting item of the image uploading node, an image stored in a set storage path as the first filter image; or determining, in response to an image selection operation and an image drag-and-drop operation of dragging-and-dropping a selected image to a target node region of the image uploading node, the dragged-and-dropped image as the first filter image, and displaying the first filter image in association with the image uploading node.

According to one or more embodiments of the present disclosure, [Example 7] provides the method of Example 1, further including: optionally, the converting the first filter image into a second filter image through the filter image conversion node includes: parsing, through the filter image conversion node, the first filter image into a third filter image and creating a filter grid image with a second format, and writing a pixel color in the third filter image into the filter grid image to obtain the second filter image.

According to one or more embodiments of the present disclosure, [Example 8] provides the method of Example 1, further including: optionally, before the obtaining a set first filter image, the method further includes: displaying, in response to a filter effect adjustment operation on a standard filter image, a filter effect editing interface, wherein a filter parameter setting item and a template image are displayed on the filter effect editing interface; applying, in response to a parameter setting operation on the filter parameter setting item, a set target filter parameter to the template image, so as to obtain an image filter effect of the template image; generating, in response to an effect determination operation on the image filter effect, the first filter image based on the target filter parameter and the standard filter image.

According to one or more embodiments of the present disclosure, [Example 9] provides an image processing apparatus, which includes: an editing interface display module, configured to display an image editing interface, wherein the image editing interface includes at least one node identifier corresponding to an image editing node, and the image editing node includes a filter image conversion node; a conversion node adding module, configured to add, in response to an identifier triggering operation on the node identifier corresponding to the filter image conversion node, the filter image conversion node to the image editing interface; a filter image generation module, configured to obtain, in response to an image setting operation on the filter image conversion node, a set first filter image, and to convert the first filter image into a second filter image through the filter image conversion node.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An image processing method, comprising:
displaying an image editing interface, wherein the image editing interface comprises at least one node identifier corresponding to an image editing node, and the image editing node comprises a filter image conversion node;
adding, in response to an identifier triggering operation on the node identifier corresponding to the filter image conversion node, the filter image conversion node to the image editing interface; and
obtaining, in response to an image setting operation on the filter image conversion node, a set first filter image, and converting the first filter image into a second filter image through the filter image conversion node.

2. The image processing method according to claim 1, wherein after the converting the first filter image into a second filter image through the filter image conversion node, the image processing method further comprises:
determining a filter image identifier corresponding to the second filter image, storing the second filter image in a target storage space by using the filter image identifier, and updating the filter image identifier of the second filter image to a filter identifier list, wherein the filter identifier list comprises a filter image identifier corresponding to a candidate filter image.

3. The image processing method according to claim 2, wherein the image editing node comprises a filter image application node, the filter image application node comprises an application image setting item and a filter image setting item; after the updating the filter image identifier of the second filter image to a filter identifier list, the image processing method further comprises:
obtaining, in response to an image setting operation on the application image setting item of the filter image application node, an image to be processed; and displaying, in response to an image setting operation on the filter image setting item of the filter image application node, the filter identifier list;
determining, in response to an identifier triggering operation on the filter image identifier in the filter identifier list, a target filter image in the candidate filter image according to the triggered filter image identifier, and filtering the image to be processed through the target filter image, so as to obtain a filter effect image.

4. The image processing method according to claim 3, wherein the filter image application node further comprises a filter degree setting item; after the displaying an image editing interface, the image processing method further comprises:
obtaining, in response to a filter degree setting operation on the filter degree setting item of the filter image application node, a set filter degree parameter; and
the filtering the image to be processed through the target filter image comprises:
filtering the image to be processed through the set filter degree parameter and the target filter image.

5. The image processing method according to claim 1, wherein the filter image conversion node comprises a conversion image setting item; the obtaining, in response to an image setting operation on the filter image conversion node, a set first filter image, comprises:
obtaining, in response to an image setting operation on the conversion image setting item of the filter image conversion node, the set first filter image.

6. The image processing method according to claim 1, wherein the image editing node comprises an image uploading node; the obtaining, in response to an image setting operation on the filter image conversion node, a set first filter image, comprises:
when the image uploading node comprises a storage path setting item, obtaining, in response to a storage path setting operation on the storage path setting item of the image uploading node, an image stored in a set storage path as the first filter image; or
determining, in response to an image selection operation and an image drag-and-drop operation of dragging-and-dropping a selected image to a target node region of the image uploading node, the dragged-and-dropped image as the first filter image, and displaying the first filter image in association with the image uploading node.

7. The image processing method according to claim 1, wherein the converting the first filter image into a second filter image through the filter image conversion node comprises:
parsing, through the filter image conversion node, the first filter image into a third filter image and creating a filter grid image with a second format, and writing a pixel color in the third filter image into the filter grid image to obtain the second filter image.

8. The image processing method according to claim 1, wherein before the obtaining a set first filter image, the image processing method further comprises:
displaying, in response to a filter effect adjustment operation on a standard filter image, a filter effect editing interface, wherein a filter parameter setting item and a template image are displayed on the filter effect editing interface;
applying, in response to a parameter setting operation on the filter parameter setting item, a set target filter parameter to the template image, so as to obtain an image filter effect of the template image; and
generating, in response to an effect determination operation on the image filter effect, the first filter image based on the target filter parameter and the standard filter image.

9. The image processing method according to claim 2, wherein the filter image conversion node comprises a conversion image setting item; the obtaining, in response to an image setting operation on the filter image conversion node, a set first filter image, comprises:
obtaining, in response to an image setting operation on the conversion image setting item of the filter image conversion node, the set first filter image.

10. The image processing method according to claim 2, wherein the image editing node comprises an image uploading node; the obtaining, in response to an image setting operation on the filter image conversion node, a set first filter image, comprises:
when the image uploading node comprises a storage path setting item, obtaining, in response to a storage path setting operation on the storage path setting item of the image uploading node, an image stored in a set storage path as the first filter image; or
determining, in response to an image selection operation and an image drag-and-drop operation of dragging-and-dropping a selected image to a target node region of the image uploading node, the dragged-and-dropped image as the first filter image, and displaying the first filter image in association with the image uploading node.

11. The image processing method according to claim 2, wherein the converting the first filter image into a second filter image through the filter image conversion node comprises:
parsing, through the filter image conversion node, the first filter image into a third filter image and creating a filter grid image with a second format, and writing a pixel color in the third filter image into the filter grid image to obtain the second filter image.

12. The image processing method according to claim 2, wherein before the obtaining a set first filter image, the image processing method further comprises:
displaying, in response to a filter effect adjustment operation on a standard filter image, a filter effect editing interface, wherein a filter parameter setting item and a template image are displayed on the filter effect editing interface;
applying, in response to a parameter setting operation on the filter parameter setting item, a set target filter parameter to the template image, so as to obtain an image filter effect of the template image;
generating, in response to an effect determination operation on the image filter effect, the first filter image based on the target filter parameter and the standard filter image.

13. The image processing method according to claim 3, wherein the filter image conversion node comprises a conversion image setting item; the obtaining, in response to an image setting operation on the filter image conversion node, a set first filter image, comprises:
obtaining, in response to an image setting operation on the conversion image setting item of the filter image conversion node, the set first filter image.

14. The image processing method according to claim 3, wherein the image editing node comprises an image uploading node; the obtaining, in response to an image setting operation on the filter image conversion node, a set first filter image, comprises:
when the image uploading node comprises a storage path setting item, obtaining, in response to a storage path setting operation on the storage path setting item of the image uploading node, an image stored in a set storage path as the first filter image; or
determining, in response to an image selection operation and an image drag-and-drop operation of dragging-and-dropping a selected image to a target node region of the image uploading node, the dragged-and-dropped image as the first filter image, and displaying the first filter image in association with the image uploading node.

15. The image processing method according to claim 3, wherein the converting the first filter image into a second filter image through the filter image conversion node comprises:
parsing, through the filter image conversion node, the first filter image into a third filter image and creating a filter grid image with a second format, and writing a pixel color in the third filter image into the filter grid image to obtain the second filter image.

16. The image processing method according to claim 3, wherein before the obtaining a set first filter image, the image processing method further comprises:
displaying, in response to a filter effect adjustment operation on a standard filter image, a filter effect editing interface, wherein a filter parameter setting item and a template image are displayed on the filter effect editing interface;
applying, in response to a parameter setting operation on the filter parameter setting item, a set target filter parameter to the template image, so as to obtain an image filter effect of the template image;
generating, in response to an effect determination operation on the image filter effect, the first filter image based on the target filter parameter and the standard filter image.

17. The image processing method according to claim 4, wherein the filter image conversion node comprises a conversion image setting item; the obtaining, in response to an image setting operation on the filter image conversion node, a set first filter image, comprises:
obtaining, in response to an image setting operation on the conversion image setting item of the filter image conversion node, the set first filter image.

18. The image processing method according to claim 4, wherein the image editing node comprises an image uploading node; the obtaining, in response to an image setting operation on the filter image conversion node, a set first filter image, comprises:
when the image uploading node comprises a storage path setting item, obtaining, in response to a storage path setting operation on the storage path setting item of the image uploading node, an image stored in a set storage path as the first filter image; or
determining, in response to an image selection operation and an image drag-and-drop operation of dragging-and-dropping a selected image to a target node region of the image uploading node, the dragged-and-dropped image as the first filter image, and displaying the first filter image in association with the image uploading node.

19. An electronic device, comprising:
at least one processor;
at least one memory, configured to store at least one program, wherein
when the at least one program is executed by the at least one processor, the at least one processor is caused to implement an image processing method, comprising:
displaying an image editing interface, wherein the image editing interface comprises at least one node identifier corresponding to an image editing node, and the image editing node comprises a filter image conversion node;
adding, in response to an identifier triggering operation on the node identifier corresponding to the filter image conversion node, the filter image conversion node to the image editing interface; and
obtaining, in response to an image setting operation on the filter image conversion node, a set first filter image, and converting the first filter image into a second filter image through the filter image conversion node.

20. A non-transitory computer-readable storage medium, containing computer-executable instructions, wherein the computer-executable instructions, when executed by a computer processor, are configured to execute an image processing method, comprising:
displaying an image editing interface, wherein the image editing interface comprises at least one node identifier corresponding to an image editing node, and the image editing node comprises a filter image conversion node;
adding, in response to an identifier triggering operation on the node identifier corresponding to the filter image conversion node, the filter image conversion node to the image editing interface; and
obtaining, in response to an image setting operation on the filter image conversion node, a set first filter image, and converting the first filter image into a second filter image through the filter image conversion node.
